(19) United States
(12) Patent Application Publication
(10) Pub. No.: US 2009/0185184 A1
(43) Pub. Date: Jul. 23, 2009

(54) ALIGNMENT APPARATUS FOR MANUFACTURING A LIQUID JET HEAD, AN ALIGNMENT METHOD FOR MANUFACTURING THE SAME AND METHOD OF MANUFACTURING A LIQUID JET HEAD UNIT

(75) Inventors: Yasuo Inaoka, Suwa-shi (JP); Takuma Okamuro, Suwa-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/355,635

(22) Filed: Jan. 16, 2009

(30) Foreign Application Priority Data
Jan. 17, 2008 (JP) 2008-008516

(51) Int. Cl. G01B 11/00

(52) U.S. Cl. 356/401

(57) ABSTRACT

An alignment apparatus includes a mask 410 which has a reference mark 401 at which an alignment mark 22 of an ink jet recording head 220 is positioned and a bifocal microscope 500 which has a first optical system 501 having an optical axis L1 and a second optical system 502 having an optical axis L2 and in which the first optical system 501 can focus on the reference mark 401 and the second optical system 502 can focus on the alignment mark 22. The bifocal microscope 500 is provided with optical axis adjustment means 520 which adjusts a direction of a reflection face of a second mirror 509 so that the optical axes L1 and L2 coincident with each other are incident to the reference mark 401 and the alignment mark 22.

### BACKGROUND

The entire disclosure of Japanese Patent Application No. 2008-008516, filed Jan. 17, 2008 is incorporated by reference herein.

1. Technical Field

The present invention relates to an alignment apparatus for a liquid jet head and an alignment method for the liquid jet head.

2. Related Art

Ink jet recording apparatuses such as ink jet printers and ink jet plotters have an ink jet recording head unit (hereinafter, referred to as the head unit) including an ink jet recording head for ejecting, as ink droplets, ink stored in a liquid storing portion such as an ink cartridge or an ink tank from a nozzle opening provided in a nozzle plate. The ink jet recording head provided in the head unit is positioned (aligned) at a predetermined position to be bonded to a fixing member such as a fixing plate (for example, see JP-A-2002-160376).

Such positioning is performed by moving the ink jet recording head so as to match an alignment mark provided in a liquid ejection face (for example, nozzle plate) of the ink jet recording head with a reference mark provided in a glass mask having a flat plate shape.

Herein, it is necessary that the reference mark is brought as close as possible to the alignment mark to perform high-accuracy positioning. Accordingly, there has been proposed a method of performing a predetermined alignment operation by bring the nozzle plate into close contact with the glass mask (for example, JP-A-2004-345281).

However, as described above, when the nozzle plate is brought into close contact with the glass mask, foreign substances may be caught between the nozzle plate and the glass mask and a surface of the glass mask and the like may be scratched.

In order to solve the problems, it is preferable that a space is provided between the glass mask and the nozzle plate. However, at this time, a distance between the reference mark and the alignment mark becomes large by the space and thus it causes a problem in that accuracy of positioning is affected. That is, when the reference mark of the glass mask and the alignment mark of the nozzle plate are observed by one optical system at a time, it is necessary to employ a large depth of field. However, as the depth of field increases, a magnification of the optical system cannot be raised. This becomes an obstacle when high-accuracy positioning is required.

In addition, a method in which when observing the reference mark and the alignment mark distant from each other, the reference mark is observed by focusing on the reference mark and then a lens is moved in an optical axis direction thereof to focus on the alignment mark and observe the reference mark is also provided. However, in this case, since movement accuracy of the lens has an effect on alignment accuracy, high-accuracy more than a certain level cannot be expected.

The problems occur upon alignment associated with the manufacturing of the ink jet recording head unit as well as upon alignment associated with the manufacturing of another liquid jet head unit.

### SUMMARY

The invention is contrived in view of conventional techniques as described above, and an object of the invention is to provide an alignment apparatus for a liquid jet head and an alignment method for the liquid jet head, which can perform high-accuracy positioning even when a reference mark and an alignment mark are distant from each other.

According to a first aspect of the invention for achieving the object, a liquid jet head alignment apparatus which positions a plurality of liquid jet heads, each of which ejects liquid from a nozzle opening provided in a nozzle plate, includes: a mask as a transparent member which has a reference mark at which an alignment mark provided in the liquid ejection face of each of the respective liquid jet heads is positioned; and a bifocal microscope having two optical systems which have optical axes directed toward the reference mark and the alignment mark from the side opposite to the liquid jet heads in the mask, respectively. The optical systems include a first optical system capable of focusing on the reference mark and a second optical system capable of focusing on the alignment mark. The first optical system and the second optical system are configured, so that at least one of the optical axes of the first optical system and the second optical system reflects via a mirror and the optical axes reach external image pick-up means. The bifocal microscope is provided with optical axis adjustment means which adjusts a direction of a reflection face of the mirror.

In such an aspect, directions of the optical axes of the optical systems of the bifocal microscope, which are incident to the reference mark and the alignment mark, can be made coincident with each other. Accordingly, positioning of the liquid jet heads can be performed with high accuracy, so that the reference mark and the alignment mark are completely coincident with each other when the positioned liquid jet heads and the mask are viewed in a plan view.

In addition, it is preferable that the first optical system and the second optical system are configured so that the optical axes reflect via mirrors provided in the first optical system and the second optical system, respectively, and that one mirror is fixed so that the optical axis passing through the mirror is incident perpendicular to the reference mark and the alignment mark and the other mirror is configured so that a direction of a reflection face thereof is adjusted by the optical axis adjustment means. According to the above description, one mirror is fixed so that one optical axis is incident perpendicular to the reference mark. Accordingly, by adjusting only the other mirror, the optical axes can be easily made coincident with each other, and the optical axes can be made incident perpendicular to the reference mark and the alignment mark.

According to another aspect of the invention, a liquid jet head alignment method of positioning a plurality of liquid jet heads, each of which ejects liquid from a nozzle opening, by using a bifocal microscope which has first and second optical systems which can adjust focus positions on two subjects, respectively, and in which at least one of optical axes of the first optical system and the second optical system reflects via a mirror and the optical axes reach external image pick-up means, includes: adjusting a direction of a reflection face of the mirror so that the optical axes of the first optical system and the second optical system coincident with each other are incident to a reference mark of a mask as a transparent member provided with the reference mark at which the alignment mark is positioned; opposing the mask to the liquid jet heads; and focusing on the reference mark by the first optical system and focusing on the alignment mark by the second optical system to obtain images of the reference mark and the alignment mark and moving the respective liquid jet heads to a position in which the images overlap each other to be positioned.

In such an aspect, by the optical axis adjustment means, directions of the optical axes of the optical systems of the bifocal microscope, which are incident to the reference mark and the alignment mark, can be made coincident with each other. Accordingly, positioning of the liquid jet heads can be performed with high accuracy, so that the reference mark and the alignment mark are completely coincident with each other when the positioned liquid jet heads and the mask are viewed in a plan view.

### BRIEF DESCRIPTION OF THE DRAWINGS

FIG. 1 illustrates an exploded perspective view of a head unit according to an embodiment.

FIG. 2 illustrates a perspective view of an assembled state of the head unit according to the embodiment.

FIG. 3 illustrates a sectional view of a main part of the head unit according to the embodiment.

FIG. 4 illustrates a sectional view of an alignment apparatus according to the embodiment.

FIG. 5 illustrates sectional views of a main part of a mask and a mirror and schematic diagrams of a mirror image and an image of a reference mark.

FIG. 6 illustrates bottom views explaining an alignment method according to the embodiment.

20: NOZZLE PLATE
21: NOZZLE OPENING
22: ALIGNMENT MARK
220: INK JET RECORDING HEAD
400: ALIGNMENT JIG
401: REFERENCE MARK
410: MASK
500: BIFOCAL MICROSCOPE
501: FIRST OPTICAL SYSTEM
502: SECOND OPTICAL SYSTEM
512: OPTICAL AXIS ADJUSTMENT MEANS

### DESCRIPTION OF EXEMPLARY EMBODIMENTS

Before describing an alignment apparatus according to an embodiment of the invention, it will be described an example of an ink jet recording head unit having an ink jet recording head which is a kind of a liquid jet head as a target for alignment.

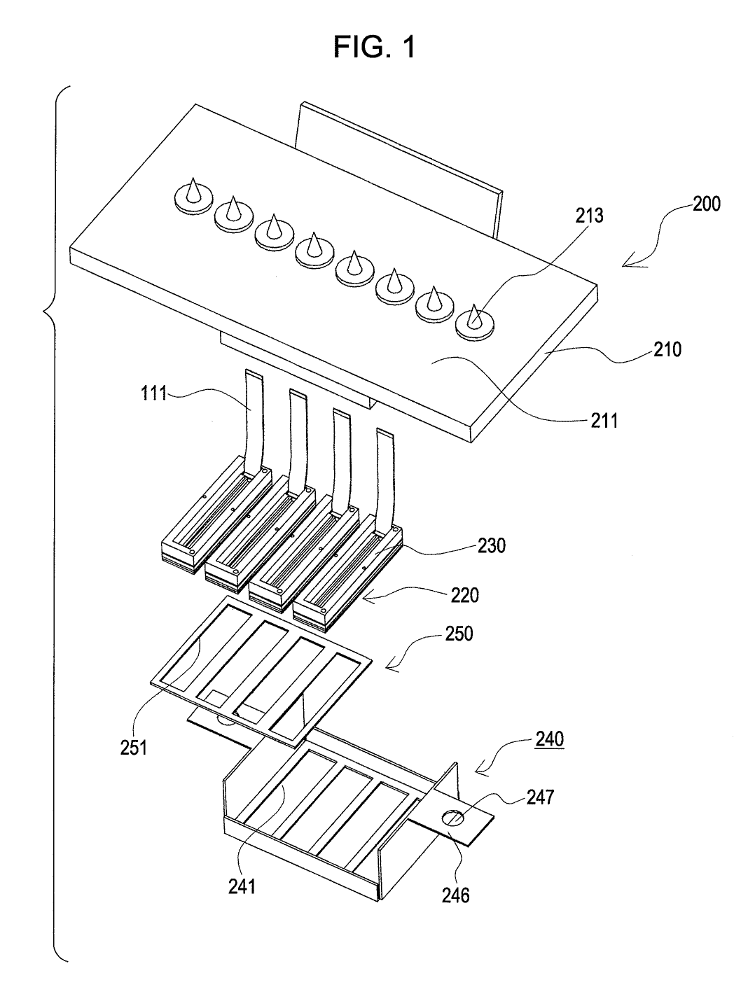

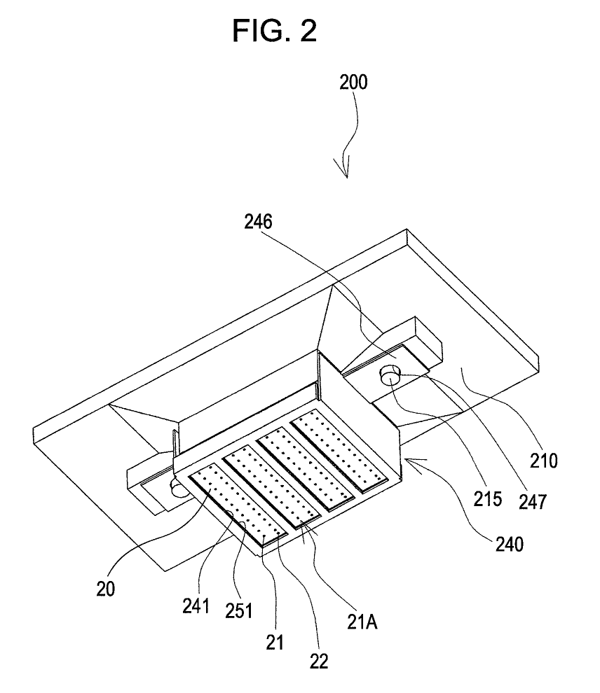

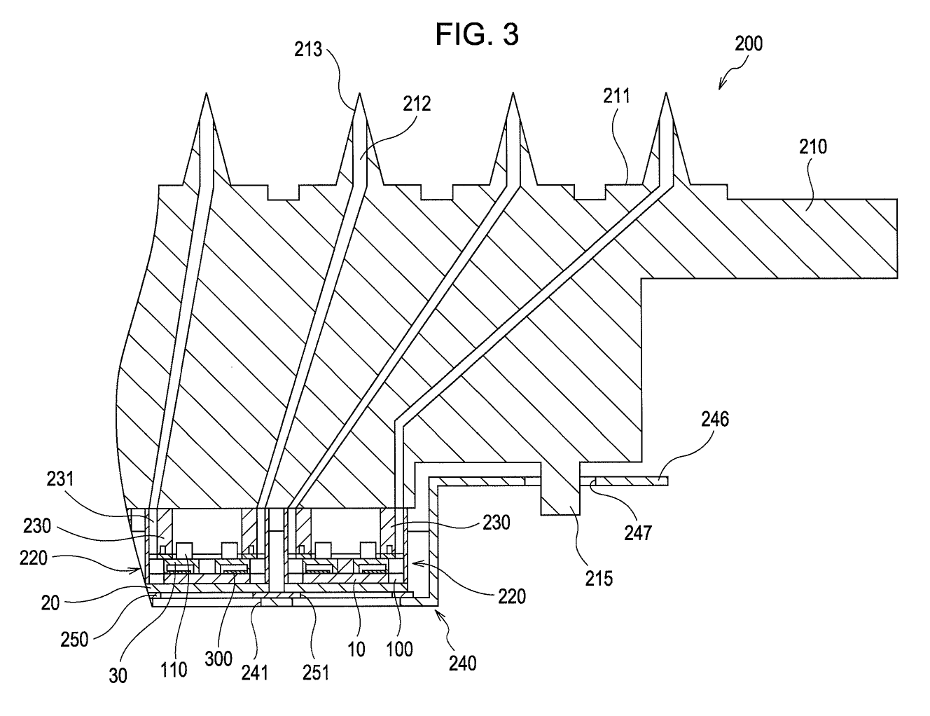

FIG. 1 is an exploded perspective view of an ink jet recording head unit, FIG. 2 is a perspective view of an assembled state of the ink jet recording head unit and FIG. 3 is a sectional view of a main part of the ink jet recording head unit.

As illustrated in the drawings, an ink jet recording head unit 200 (hereinafter, referred to as the head unit 200) has a cartridge case 210, ink jet recording heads 220, a cover head 240 and a fixing plate 250.

Among them, the cartridge case 210 is an ink cartridge holding member having a cartridge mounting portion 211 on which ink cartridges (not shown) are mounted. The ink cartridges are, for example, ink supply means configured by different bodies filled with black ink and three colors of color inks, respectively. That is, the ink cartridges for the respective colors are mounted on the cartridge case 210.

In addition, as particularly illustrated in FIG. 3, the cartridge case 210 is provided with plural ink communication passages 212, each of which has one end which is open to the cartridge mounting portion 211 and the other end which is open to a head case 230. Further, an ink supply needle 213 inserted into an ink supply port of the ink cartridge is fixed to the open portion of the ink communication passage 212 of the cartridge mounting portion 211. The above fixation is achieved via a filter (not shown) which is formed in the ink communication passage 212 to remove foreign substances and bubbles in ink.

The ink jet recording heads 220 each have a nozzle plate 20 which is provided with nozzle openings 21 for ejecting ink, a channel formation substrate 10 in which a pressure generation chamber communicating with the nozzle openings 21 is formed, a piezoelectric element 300 for applying a pressure for ejecting ink to the pressure generation chamber, a protective substrate 30 which is provided on the side on which the piezoelectric element 300 of the channel formation substrate 10 is provided. A reservoir 100 as an ink chamber communicating with the pressure generation chamber is formed in the channel formation substrate 10 and the protective substrate 30.

One nozzle plate 20 is provided with two nozzle arrays 21A in which the nozzle openings 21 are arranged and alignment marks 22 (to be described later in detail) which are used upon positioning. In this embodiment, the number of the alignment marks 22, each of which is provided at an end in an arrangement direction of the nozzle openings 21, is two. The alignment mark 22 can be easily formed by processing with a punch in a process of forming the nozzle openings 21 by the punch.

Each ink jet recording head 220 is fixed to the fixing plate 250 in a state in which the ink jet recording head 220 is aligned at a predetermined position by an alignment apparatus to be described later with the use of the alignment marks 22. The fixing plate 250 is provided with opening portions 251 for exposing the nozzle openings 21.

Moreover, each ink jet recording heads 220 is fixed to a bottom face of the cartridge case 210 via the head case 230. The head case 230 is provided with an ink supply communication passage 231 as a through hole and ink is supplied to the reservoir 100 of the ink jet recording head 220 from the ink communication passage 212 via the ink supply communication passage 231.

As illustrated in FIGS. 1 and 2, the head unit 200 is provided with the cover head 240 which has a box shape to cover the ink jet recording heads 220 on the side opposite to the ink jet recording heads 220 with respect to the fixing plate 250. The cover head 240 is provided with opening portions 241 corresponding to the opening portions 251 of the fixing plate 250.

The cover head 240 is provided with flange portions 246 each provided with a fixing hole 247 for positioning and fixing the cover head 240 to the cartridge case 210. Meanwhile, the cartridge case 210 is provided with protrusion portions 215 which protrude toward an ink droplet ejection face and are inserted into the fixing holes 247 of the cover head 240, respectively. By inserting the protrusion portions 215 into the fixing holes 247 of the cover head 240 and thermal-caulking front end portions of the protrusion portions 215, the cover head 240 is fixed to the cartridge case 210.

In the head unit 200 having the above configuration, ink from the ink cartridges is filled from the reservoirs 100 of the ink jet recording heads 220 to the nozzle openings 21 via the ink communication passages 212 and the ink supply communication passages 231. In this state, each ink jet recording head 220 applies a voltage to the piezoelectric element 300 corresponding to the pressure generation chamber in accordance with a recording signal from a driving IC 110 to subject the piezoelectric element 300 to flexural deformation. In this manner, a pressure in each pressure generation chamber is increased and thus ink droplets are ejected from the nozzle openings 21.

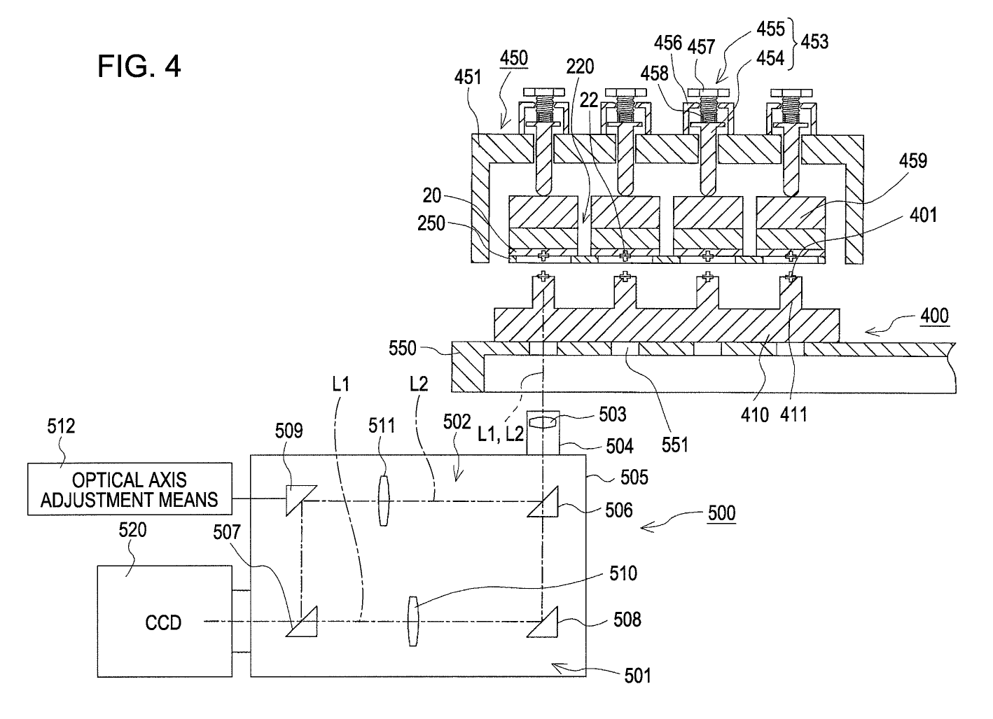

The alignment apparatus according to this embodiment will be described in detail based on the drawings. FIG. 4 is a sectional view illustrating the alignment apparatus according to this embodiment. The same reference numbers are given to the same portions of FIGS. 1 to 3. As illustrated in the drawing, the alignment apparatus according to this embodiment has an alignment jig 400 on which the ink jet recording heads 220 as targets for alignment are placed, pressing means 450 which is formed integrally with the alignment jig 400 to press the ink jet recording heads 220 on the fixing plate 250, a bifocal microscope 500 which has two optical systems for observing the ink jet recording heads 220 from below the alignment jig 400 via the alignment jig 400 and a moving stage 550 to which a mask 410 is fixed and which can be arbitrarily moved in a horizontal direction perpendicular to optical axes L1 and L2 of the bifocal microscope 500.

Among them, the alignment jig 400 is provided with at least the mask 410 which is a transparent member provided with reference marks 401. The transparent member is a member which has transparency to discern the alignment marks on the opposite side. Specifically, glass, plastic or the like is used, but it is obvious that the invention is not limited to the specific members if they can be used to achieve the object of the invention.

Specifically, the mask 410 is made of a material having transparency, for example, glass such as quartz. In this embodiment, the mask has convex portions 411 each having reference marks 401 at a front end portion thereof and protruding toward the ink jet recording head 220 from a body portion of the mask 410 in a state of not being brought into contact with the ink jet recording head 220. The convex portions 411 having a cylindrical shape are provided to correspond to the reference marks 401, respectively. In this embodiment, since a liquid ejection face of each ink jet recording head 220, for example, the nozzle plate 20 is provided with two alignment marks 22, the number of the reference marks 401 in each ink jet recording head 220 is two. That is, a total number of the provided reference marks is 8. Herein, the nozzle plate 20 is provided with the alignment marks 22. However, the alignment marks are not limited to the nozzle plate 20 as long as it is a liquid ejection face of the ink jet recording head 220.

As described above, the alignment jig 400 is provided with the pressing means 450 for pressing the ink jet recording heads 220 on the fixing plate 250. That is, the pressing means 450 is provided with an arm portion 451 which has a U-shape and is disposed on the ink jet recording heads 220 and pressing portions 453 which are provided in the arm portion 451 and press the ink jet recording heads 220 on the fixing plate 250.

The pressing portions 453 are provided in areas opposed to the ink jet recording heads 220 of the arm portion 451, respectively. In this embodiment, since 4 ink jet recording heads 220 are fixed to one fixing plate 250, the number of the pressing portions 453 provided to correspond to the ink jet recording heads 220 is 4, which is the same as the number of the ink jet recording heads.

Each pressing portion 453 includes a pressing pin 454 which has a cylindrical shape and is inserted into the arm portion 451 to be provided movably in an axial direction, urging means 455 which is provided at a base end portion of the pressing pin 454 to urge the pressing pin 454 toward the ink jet recording head 220 and a pressing piece 459 which is disposed between the pressing pin 454 and the ink jet recording head 220.

The pressing pin 454 has a front end formed in a hemispherical shape to come into point-contact with the pressing piece 459 so as to press the pressing piece 459.

The urging means 455 urges the pressing pin 454 provided in the arm portion 451 toward the ink jet recording head 220. In this embodiment, the urging means is provided with a screw holding portion 456 which is provided so as to surround the base end portion of the pressing pin 454, a screw portion 457 which is threadably mounted on the screw holding portion 456 and an urging spring 458 which is provided between a front end face of the screw portion 457 and the base end portion of the pressing pin 454. Thus, the urging means 455 can adjust a pressure of the urging spring 458 pressing the pressing pin 454 in accordance with a tightening amount of the screw portion 457 relative to the screw holding portion 456. Accordingly, a pressure of the pressing pin 454 pressing the pressing piece 459 can be adjusted.

The pressing piece 459 is disposed between the pressing pin 454 and the protective substrate 30 of the ink jet recording head 220 and can press the ink jet recording head 220 in a state in which the pressing pin 454 comes into point-contact with an upper face of the pressing piece 459 and a pressing force of the pressing pin 454 is uniformly propagated to almost the entire face on the protective substrate 30 of the ink jet recording head 220. The pressing piece 459 has the same size as an outer circumferential shape of the protective substrate 30 of the ink jet recording head 220 or has a slightly smaller outer circumferential shape.

The alignment jig 400 formed integrally with the pressing means 450 as described above is disposed on the moving stage 550 so as to be arbitrarily moved in the horizontal direction perpendicular to the optical axes L1 and L2 of the bifocal microscope 500. As a result, in a state in which the optical axes L1 and L2 are fixed, by moving the moving stage 550, the alignment marks 22 corresponding to the respective ink jet recording heads 220 can face the respective reference marks 401 on the optical axes L1 and L2. In an area through which the optical axes L1 and L2 pass toward the mask 410 in the moving stage 550, through holes 551 are provided to ensure optical paths up to the alignment marks 22 via the reference marks 401.

The bifocal microscope 500 is provided with a first optical system 501 and a second optical system 502, and they have the optical axes L1 and L2 (shown by the dashed line in the drawing) directed in a direction of the reference mark 401 and the alignment mark 22 from the opposite side of the ink jet recording head 220 of the mask 410, respectively. The first optical system 501 is configured to focus on the reference mark 401 and the second optical system 502 is configured to focus on the alignment mark 22.

Specifically, a field lens 503 is received in a lens barrel 504 so as to direct the optical axes L1 and L2 in the direction of the reference mark 401 and the alignment mark 22 and the lens barrel 504 is fixed to a housing 505. A first beam splitter 506, a second beam splitter 507, a first mirror 508, a second mirror 509, a first focus lens 510 and a second focus lens 511 are received in the housing 505.

The first optical system 501 is configured by the first beam splitter 506, the first mirror 508, the first focus lens 510 and the second beam splitter 507. The optical axis L1 of the first optical system 501 is transmitted through the first beam splitter 506, is reflected by the first mirror 508, reflects via the first focus lens 510 and then is transmitted through the second beam splitter 507 to reach a CCD 520 which is external image pick-up means. In this embodiment, the first mirror 508 is fixed to the housing 505 so that the optical axis L1 is incident perpendicular to the alignment mark 22.

The second optical system 502 is configured by the first beam splitter 506, the second focus lens 511, the second mirror 509 and the second beam splitter 507. Regarding the optical axis L2 of the second optical system 502, light reflected by the first beam splitter 506 reflects via the focus lens 511 and then is reflected by the second mirror 509 and the second beam splitter 507 to reach the external CCD 520.

The second mirror 509 is mounted on the housing 505 so as to freely change a direction of a reflection face of the second mirror. Moreover, the bifocal microscope 500 is provided with optical axis adjustment means 512 for adjusting the direction of the reflection face of the second mirror 509. Specifically, the optical axis adjustment means 512 is configured to adjust the direction of the reflection face of the second mirror 509 by adjusting a mounting angle of the second mirror 509 on the housing 505. It is preferable that a micrometer head is used as such optical axis adjustment means 512, but the invention is not limited to this.

In this manner, by changing the angle of the second mirror 509 via the optical axis adjustment means 512, the direction of the reflection face of the second mirror can be changed, and as a result, the angle of the optical axis L2 incident to the reference mark 401 can be changed.

The CCD 520 as the image pick-up means captures images of the reference mark 401 and the alignment mark 22 via the first and second optical systems 501 and 502 at the same time and reproduces the images. Herein, a focus position of the focus lens 510 is adjusted for the reference mark 401 and a focus position of the focus lens 511 is adjusted for the alignment mark 22 so as to form focused images on the CCD 520, respectively. Thus, clear images in which the reference mark 401 and the alignment mark 22 are in focus, respectively, can be obtained on the CCD 520.

Using the alignment apparatus having the above configuration, a relative positional relationship between the reference mark 401 of the mask 410 fixed to the moving stage 550 and the alignment mark 22 of the nozzle plate 20 can be confirmed by the bifocal microscope 500 and positioning of the reference mark 401 and the alignment mark 22 can be performed.

Herein, as described above, the angle of the reflection face of the second mirror 509 can be adjusted. Accordingly, by operating the optical axis adjustment means 512, the direction of the optical axis L2 is adjusted to be coincident with the direction of the optical axis L1. At this time, since the optical axis L1 is made incident perpendicular to the reference mark 401 by the first mirror 508, the optical axes L1 and L2 are incident perpendicular to the reference mark 401 and the alignment mark 22.

As described above, when the ink jet recording heads 220 are positioned by using the bifocal microscope 500 in which the optical axes L1 and L2 are adjusted to be coincident with each other and be incident perpendicular to the reference mark 401 and the alignment mark 22, the alignment mark 22 moved to be positioned on the optical axis L2 is positioned on the optical axis L1 at the same time. That is, the positioning is performed in a state in which the alignment marks 22 of the ink jet recording heads 220 and the reference marks 401 of the mask 410 are completely coincident with each other, respectively. Herein, “completely coincident” means that the reference marks 401 and the alignment marks 22 are coincident with each other when the positioned ink jet recording heads 220 and the mask 410 are viewed in a plan view.

Herein, assuming that the optical axes L1 and L2 are not coincident with each other and the optical axis L2 is tilted toward the optical axis L1, the actual positions of the ink jet recording heads 220 are deviated from original positions thereof by the tilt of the optical axis L2, even when the positioning of the ink jet recording heads 220 is performed so that images of the reference marks 401 and images of the alignment marks 22 are coincident with each other on images obtained by the CCD 520. That is, when the positioned ink jet recording heads 220 and the mask 410 are viewed in a plan view, the alignment marks 22 are deviated as if wholly moved in parallel from the reference marks 401, respectively. In this state, when the ink jet recording heads 220 and the fixing plate 250 are bonded to each other, problems, including the nozzle arrays 21A leaned toward one side of the opening portion 251 of the fixing plate 250, occur in that the ink jet recording heads 220 are not fixed to the fixing plate 250 at appropriate positions.

However, according to the alignment apparatus according to the invention, the positional deviation caused by the deviation of the optical axes does not occur, and as a result, the head unit 200 can be configured in which the ink jet recording heads 220 are positioned with high accuracy.

Next, a method of aligning the ink jet recording heads 220 to predetermined positions thereof by using the alignment apparatus as described above will be described. In the alignment method of this embodiment, the alignment of the optical axis L1 of the first optical system 501 of the bifocal microscope 500 and the optical axis L2 of the second optical system 502 are performed before the alignment of the ink jet recording heads 220.

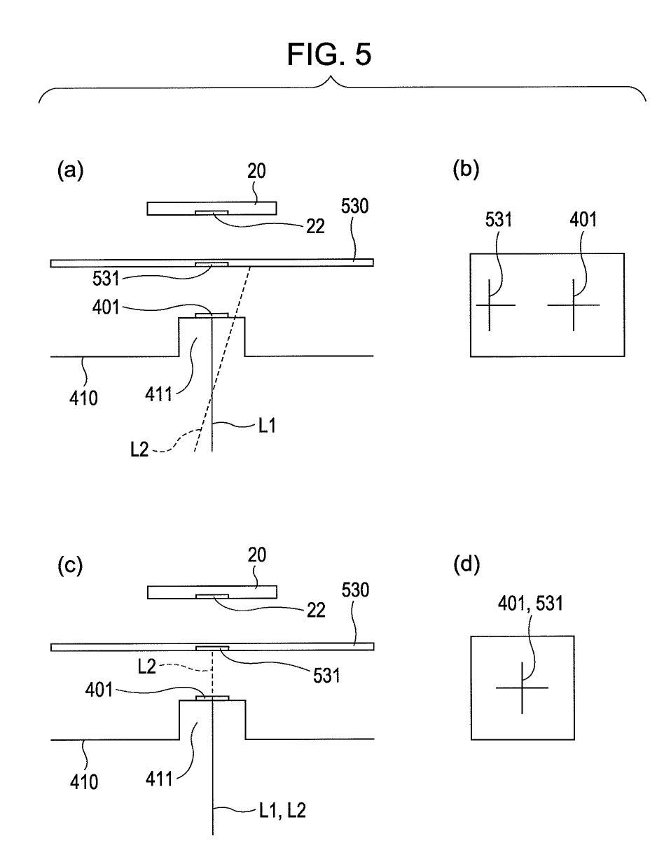

FIG. 5(a) and FIG. 5(c) are sectional views of a main part of the mask and a mirror opposed to each other and FIGS. 5(b) and 5(d) are schematic diagrams of a mirror image and an image of the reference mark displayed via the CCD.

As illustrated in FIG. 5(a), a mirror 530 is placed on a mirror jig (not shown) disposed at an arbitrary position on the stage 550, so that the mask 410 and the mirror 530 are parallel to each other. Accordingly, a mirror image 531 of the reference mark 401 of the mask 410 is reflected on a mirror face of the mirror 530. The mirror 530 is placed on the mirror jig, so that the distance from the reference mark 401 to the mirror image 531 is half the distance from the reference mark 401 to the alignment mark 22 of the nozzle plate 20. Further, the first focus lens 510 of the first optical system 501 is adjusted to match a focus position of the optical axis L1 with the reference mark 401 and the second focus lens 511 of the second optical system 502 is adjusted to match a focus position of the optical axis L2 with the mirror image 531.

At this time, since the mask 410 and the mirror 530 are parallel to each other, the reference mark 401 and the mirror image 531 are coincident with each other, as viewed in a direction normal to the mirror face of the mirror 530. However, when the optical axis L2 is not coincident with the optical axis L1, and is tilted and incident to the mirror 530, the mirror image 531 and the image of the reference mark 401 displayed via the CCD 520 are deviated from each other, as illustrated in FIG. 5(b).

Next, the angle of the second mirror 509 is adjusted via the optical axis adjustment means 512 so that the image of the reference mark 401 is coincident with the mirror image 531 as illustrated in FIG. 5(b). As a result of the adjustment, when the image of the reference mark 401 is coincident with the mirror image 531 as illustrated in FIG. 5(d), the optical axes L1 and L2 are coincident with each other and are incident perpendicular to the reference mark 401, as illustrated in FIG. 5(c).

Next, positioning of the ink jet recording heads 220 is performed.

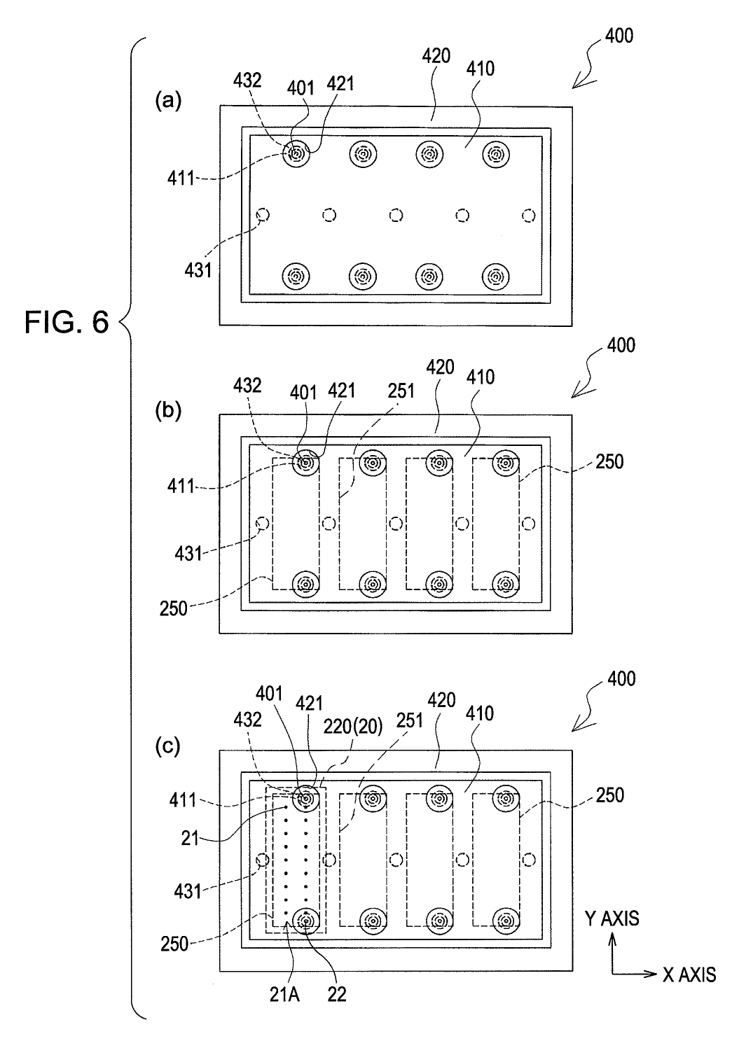

FIG. 6 illustrates bottom views of the appearance, as viewed from a bottom face of the alignment jig at the time of alignment of the ink jet recording heads.

1) As illustrated in FIG. 6(a), the mirror 530 is removed. That is, only the reference mark 401 is positioned on the optical axis L1 of the first optical system 501 of the bifocal microscope 500. As a result, on the CCD 520, a clear image in which the reference mark 401 is in focus is captured.

2) As illustrated in FIG. 6(b), the fixing plate 250 is held in the alignment jig 400.

3) As illustrated in FIG. 6(c), a focus position of the optical axis L2 of the second optical system 502 of the bifocal microscope 500 is matched with the nozzle plate 20. As a result, on the CCD 520, a clear image in which the alignment mark 22 is in focus is captured. Further, based on the image, the ink jet recording head 220 is moved so that the image of the alignment mark 22 is coincident with the image of the reference mark 401.

For the positioning of the ink jet recording head 220, position adjustment may be slightly performed with the use of a micrometer (not shown) while an operator checks the images on the CCD 520 with eyes. Moreover, for the automatic positioning of the ink jet recording head 220, a driving motor may drive the micrometer by subjecting the output images on the CCD 520 to image processing.

4) By repeating the same process as the process 3), the plural ink jet recording heads 220 are sequentially positioned. That is, while the optical axes L1 and L2 are fixed, the moving stage 550 is moved in a horizontal plane in a direction of a Y axis in FIG. 6(c) to position different alignment mark 22 and reference mark 401 of the same ink jet recording head 220, and is moved in a direction of a X axis to position the alignment mark 22 and the reference mark 401 of the adjacent different ink jet recording head 220.

5) By the pressing means 450, the plural ink jet recording heads 220 are pressed on the fixing plate 250 with a predetermined pressure, and the ink jet recording heads 220 and the fixing plate 250 are bonded to each other by curing an adhesive.

In this manner, by positioning the plural ink jet recording heads 220 and bonding them to the fixing plate 250, the head unit 200 which has the ink jet recording heads 220 positioned at predetermined positions thereof with high accuracy can be configured.

In the above-described embodiments, the angle of the second mirror 509 of the second optical system 502 is adjusted, but the invention is not limited to this. For example, the first mirror 508 may be also configured to be mounted on the housing 505 so as to freely change a direction of a reflection face of the first mirror and adjust the direction of the reflection face by the optical axis adjustment means 512.

In addition, the first optical system 501 and the second optical system 502 include the first mirror 508 and the second mirror 509, respectively. However, it is not necessarily required that the optical systems include the mirrors, respectively. At least the optical system adjusting the direction of the optical axis may include the mirror. Moreover, one CCD 520 is used as the image pick-up means, but the invention is not limited to this. One CCD 520 may be used for each of the optical axes L1 and L2 so that the images of the reference mark 401 and the alignment mark 22 are picked-up by the CCDs 520.

Further, using the mirror 530, the second mirror 509 is adjusted so that the optical axis L1 of the first optical system 501 is coincident with the optical axis L2 of the second optical system 502 toward the reference mark 401 and the mirror image 531 of the reference mark 401. However, the invention is not limited only to the adjustment using the mirror 530. In short, a target corresponding to the mirror image 531 is provided on the line normal to the face in which the reference mark 401 of the mask 410 is provided is provided, and the optical axis adjustment 512 may be operated to match the target with the optical axis L2.

Furthermore, in the above-described embodiments, the alignment jig 400 is provided with the pressing means 450, but the invention is not limited to this. For example, when an ultraviolet curable adhesive is used as the adhesive for bonding the fixing plate 250 and the ink jet recording heads 220 to each other, the adhesive is applied to an bonding face of the fixing plate 250 and then ultraviolet rays are irradiated in a state in which the ink jet recording heads 220 are brought into close contact with the fixing plate 250. In this manner, the adhesive is cured and thus the fixing plate 250 and the ink jet recording heads 220 can be bonded to each other. Accordingly, the pressing means 450 may be not provided. The ultraviolet curable adhesive is not required to be cured while the fixing plate 250 and the ink jet recording heads 220 are pressed with a predetermined pressure like in the case of a thermosetting adhesive, and prevents the positional deviation, which is caused by the pressing, between the ink jet recording heads 220 and the fixing plate 250. Accordingly, the ink jet recording heads 220 and the fixing plate 250 can be bonded to each other with high accuracy.

In the above-described embodiments, the deflection oscillation ink jet recording heads 220 are shown, but the invention is not limited to this. It is obvious that the invention can be applied to the head unit having ink jet recording heads having various configurations, such as longitudinal oscillation ink jet recording heads in which a piezoelectric material and an electrode formation material are alternately laminated and extended and contracted in an axial direction and ink jet recording heads which eject ink droplets by bubbles generated by heating of a heater element or the like.

In the above-described embodiments, the head unit having the ink jet recording heads for ejecting ink as liquid jet heads which are targets for alignment are described as an example, but the invention is not limited to this. Normally, the invention can be widely applied upon manufacturing the liquid jet head unit having the liquid jet heads. Examples of the liquid jet heads include a recording head used for an image recording apparatus such as a printer, a color material jet head used for manufacturing a color filter such as a liquid crystal display, an electrode material jet head used for forming an electrode such as an organic EL display and a field emission display (FED) and a bioorganic material jet head used for manufacturing a bio-chip.

What is claimed is:

1. A liquid jet head alignment apparatus which positions a plurality of liquid jet heads, each of which ejects liquid from a nozzle opening provided in a nozzle plate, the alignment apparatus comprising:
a mask as a transparent member which has a reference mark at which an alignment mark provided in the liquid ejection face of each of the respective liquid jet heads is positioned; and
a bifocal microscope having two optical systems which have optical axes directed toward the reference mark and the alignment mark from the side opposite to the liquid jet heads in the mask, respectively, the optical systems including a first optical system capable of focusing on the reference mark and a second optical system capable of focusing on the alignment mark,
wherein the first optical system and the second optical system are configured, so that at least one of the optical axes of the first optical system and the second optical system reflects via a mirror and the optical axes reach external image pick-up means, and
wherein the bifocal microscope is provided with optical axis adjustment means which adjusts a direction of a reflection face of the mirror.

2. The liquid jet head alignment apparatus according to claim 1,
wherein the first optical system and the second optical system are configured so that the optical axes reflect via mirrors provided in the first optical system and the second optical system, respectively, and
wherein one mirror is fixed so that the optical axis passing through the mirror is incident perpendicular to the reference mark and the alignment mark and the other mirror is configured so that a direction of a reflection face thereof is adjusted by the optical axis adjustment means.

3. A liquid jet head alignment method of positioning a plurality of liquid jet heads, each of which ejects liquid from a nozzle opening, by using a bifocal microscope which has first and second optical systems which can adjust focus positions on two subjects, respectively, and in which at least one of optical axes of the first optical system and the second optical system reflects via a mirror and the optical axes reach external image pick-up means, the method comprising:
adjusting a direction of a reflection face of the mirror so that the optical axes of the first optical system and the second optical system coincident with each other are incident to a reference mark of a mask as a transparent member provided with the reference mark at which the alignment mark is positioned;
opposing the mask to the liquid jet heads; and
focusing on the reference mark by the first optical system and focusing on the alignment mark by the second optical system to obtain images of the reference mark and the alignment mark and moving the respective liquid jet heads to a position in which the images overlap each other to be positioned.

4. A method of manufacturing a liquid jet head unit including a plurality of liquid jet heads, each of which ejects liquid from a nozzle opening, by using a bifocal microscope which has first and second optical systems which can adjust focus positions on two subjects, respectively, and in which at least one of optical axes of the first optical system and the second optical system reflects via a mirror and the optical axes reach external image pick-up means, the method comprising:
adjusting a direction of a reflection face of the mirror so that the optical axes of the first optical system and the second optical system coincident with each other are incident to a reference mark of a mask as a transparent member provided with the reference mark at which the alignment mark is positioned;
opposing the mask to the liquid jet heads;
focusing on the reference mark by the first optical system and focusing on the alignment mark by the second optical system to obtain images of the reference mark and the alignment mark and moving the respective liquid jet heads to a position in which the images overlap each other to be positioned; and
fixing relative positions of the plurality of liquid jet heads subjected to positioning.
